(19) United States
(12) Patent Application Publication
(10) Pub. No.: US 2015/0365397 A1
(43) Pub. Date: Dec. 17, 2015

(54) WEB AUTHENTICATION METHOD AND SYSTEM

(71) Applicant: VIVOTEK INC., New Taipei (TW)

(72) Inventor: Yu-Jen CHANG, New Taipei (TW)

(21) Appl. No.: 14/738,657

(22) Filed: Jun. 12, 2015

(30) Foreign Application Priority Data
Jun. 13, 2014 (TW) 103120571

(51) Int. Cl. H04L 29/06; H04L 29/08

(52) U.S. Cl. CPC H04L 63/083; H04L 67/02; H04L 63/102

(57) ABSTRACT

In a web authentication method for launching a webpage, a HTTP GET request is sent to a server and verified for the existence therein of an authorization field. If no, an affirming message and a source code for generating a login page are sent. A piece of authorization data is inputted to the login page, at least part of which is generated based on the source code by a scripting engine of a browser. Contents required by the authorization field are generated based on the input information and sent along with the authorization field to the server by the web browser as instructed by the scripting engine through an API. The webpage is selectively launched.

### CROSS-REFERENCE TO RELATED APPLICATIONS

This non-provisional application claims priority under 35 U.S.C. §119(a) on Patent Application No. 103120571 filed in Taiwan, R.O.C on Jun. 13, 2014, the entire contents of which are hereby incorporated by reference.

### BACKGROUND

1. Technical Field

The present disclosure relates to a web authentication method applying Hypertext

Transfer Protocol (HTTP), particularly relates to a web authentication method using scripting language.

2. Description of the Related Art

Hypertext Transfer Protocol (HTTP) belongs to the application layer of the Open Systems Interconnection (OSI) model, and the basic operation is that a user agent or client sends a request to a server and the server sends back a response to the client. The original design of HTTP is stateless, that is, in the perspective of the protocol, a request is not related to the previous requests and is not for expecting the future requests. When the server wants to authenticate the client for login or further identification, the implementation of the presentation layer or session layer under the application layer in OSI model is needed.

The most flexible but more complicated implementation of client authentication method in the prior art is to provide the login page with a form by the server. The authorization data, such as account and password, are inputted to the page and submitted in a form of the path field of a HTTP GET request or the body of a HTTP POST request, wherein the path field of the HTTP GET request includes the website address. The server further uses session identification recorded in the cookie of the web browser in the client to identify the client. For security and privacy concerns, cookie is convenient but not suitable for common and sustainable usage.

In fact, when the client sends an unauthorized request, the server sends a “401 Unauthorized” error code as a response and indicates one of the basic access authentication and the digest access authentication in the WWW-Authenticate field in the header. The method is widely supported by the browser and the server. However, after the browser receives the “401 Unauthorized” error code, the behavior is unpredictable because it is not defined in HTTP. The common pop up authentication window is not accepted by the contemporary design principles and the obtained a piece of authorization data is handled by the browser and is not available for cross-platform client-side scripting.

### SUMMARY

A web authentication method for launching a webpage includes sending a Hypertext Transfer Protocol (HTTP) GET request to a server, verifying whether the HTTP GET request includes an authorization field, when the HTTP GET request does not include an authorization field, sending an affirming message and a source code for generating a login page, generating the login page according to the source code, inputting a piece of authorization data in the login page, generating contents for the authorization field according to the inputted piece of authorization data, sending the authorization field and the content of the authorization field to the sever; and launching the webpage selectively, wherein the authorization field and the content of the authorization field are sent to the server by a scripting engine of a browser through an application interface (API), and at least part of the login page is generated by the scripting engine of the browser according to the source code.

A web authentication method for launching a webpage is adapted for a server. The web authentication method includes receiving a HTTP GET request, verifying whether the HTTP GET request includes an authorization field, when the HTTP GET request does not include the authorization field, sending an affirming message and a source code for generating a login page, the login page for inputting a piece of authorization data, and receiving the authorization field and the content of the authorization field, wherein the content of the authorization field is generated according to the inputted piece of authorization data. At least part of the login page is generated by a scripting engine of a browser according to the source code, and the scripting engine of the browser indicates the browser to send the authorization field and the content of the authorization field with a HTTP POST request through a XMLHttpRequest application interface.

A web authentication system for launching a webpage includes a client including a browsing module and a scripting engine, wherein the browsing module is coupled to the scripting engine, a server couple to the client via an Internet and receiving a HTTP GET request from the client, the server verifying whether the HTTP GET request from the client includes an authorization field, wherein when the HTTP GET request does not include the authorization field, the server sends an affirming message and a source code for generating a login page to the client, the login page for inputting a piece of authorization data by the client, and the client transferring the authorization field and the content of the authorization field to the server, wherein the content of the authorization field is generated according to the inputted piece of authorization data. At least part of the login page is generated by the scripting engine of the browsing module according to the source code, and the scripting engine of the browsing module indicates the browsing module to send the authorization field and the content of the authorization field with a HTTP POST request through a XMLHttpRequest application interface.

### BRIEF DESCRIPTION OF THE DRAWINGS

The present disclosure will become more fully understood from the detailed description given hereinbelow and the accompanying drawings, which are given by way of illustration only and thus are not limitative of the present disclosure and wherein:

FIG. 1 is an interaction diagram of a client and a server in the web authentication method according to a first embodiment;

FIG. 2A and 2B are interaction diagrams of a client and a server in the web authentication method after verifying the content of the authorization field according to a first embodiment;

FIG. 3 is a block diagram of the web authentication system according to a first embodiment;

FIG. 4A is a flowchart of the sever in the web authentication method according to a first embodiment;

FIG. 4B is a flowchart of the client in the web authentication method according to a first embodiment; and

FIG. 4C is a flowchart of the sever receiving the POST request in the web authentication method according to a first embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

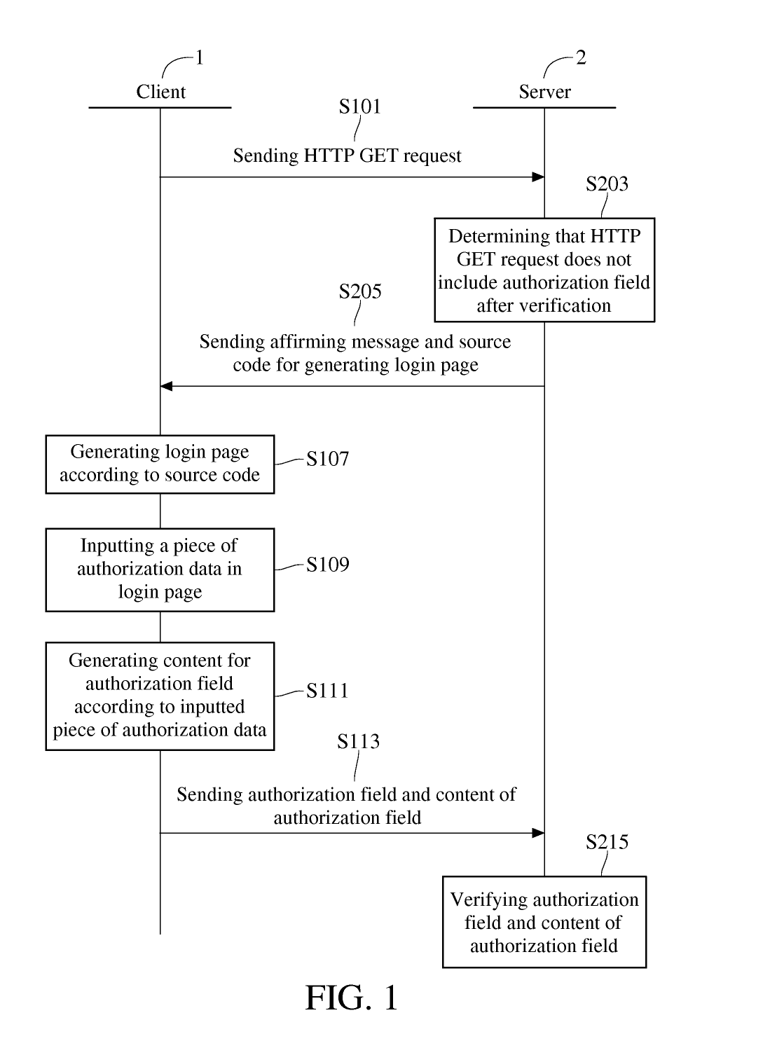

Please refer to FIG. 1. FIG. 1 is an interaction diagram of a client and a server in the web authentication method according to a first embodiment. The client 1 usually refers to the Hypertext Transfer Protocol (HTTP) requester and the subject to which the server 2 responds, and the client 1 generally refers to the browser. However, the client 1 can also be implemented with Wget and some extension functions. In the web authentication method, each request and response can follow different versions or forms of HTTP, such as version 1.1, 2.0, SPDY modification, or even applying the Gopher protocol according to the spirit of the present disclosure.

As shown in FIG. 1, in the step S101, the client 1 sends a GET request of HTTP to the server 2. The main purpose of the web authentication method is for the client 1 to obtain and launch a certain webpage or resource which requires authorization to access and is hosted by the server 2. Therefore, the GET request is in association with the webpage. Certainly, when the server 2 is specifically designed or there is an agreement between the client 1 and the server 2, the GET request is not necessary to specify the path or Internet address.

In the scenario of the present embodiment, the GET request sent by the client 1 in the step S101 does not include the authorization field, and the possible reasons of not including the authorization field are that the client 1 does not have the data for obtaining the authorization, not knowing how to obtain the authorization according to the piece of authorization data, or not knowing the access restriction of the webpage. The fact of not including the authorization field is determined after the verification by the server 2 in the step S203. The authorization field generally refers to the “Authorization” field of the message header of HTTP and is for recording the piece of authorization data or the derived data of the client 1. When the client 1 sends another request including the authorization field to the server 2, it means that the client 1 passes the authentication with the web authentication method of the present disclosure and is requesting specific resources from the server 2. The server 2 verifies whether the received request includes the authorization field. If the received request includes the authorization field, the server 2 responds selectively, such as sending specific resources to the authorized client 1.

According to the determination of the step S203, the server 2 does not respond “401 Unauthorized” in the step S205, but sends an affirming message and a source code of the login page. Generally the affirming message and the source code is part of the server response of HTTP. The affirming message is in the “status code” field and is not limited to “200 OK”. The source code is in the body of the response. The login page is for the client 1 to input the piece of authorization data and is generated or rendered by the client 1 according to the source code in the step S107. Specifically, the browser in association with the client 1 has a scripting engine. The engine interprets or executes the source code, especially the part written in the interpreted language, and generates at least part of the login page. The common interpreted languages of the webpage include JavaScript, Jscript, ActionScript, and languages satisfy ECMAScript specifications, or VBScript, wherein ECMA stands for European Computer Manufacturers Association.

In the step S109, the client 1 inputs the piece of authorization data in the rendered login page. The piece of authorization data is possibly known by the client 1 and is automatically provided by the client 1, or the client 1 waits for the user to input and reflects the piece of authorization data on the login page, such as showing the characters inputted by the user. In an embodiment, the piece of authorization data includes the user name and the corresponding password. Therefore, the login page includes the two fields for users to key in and the two fields form part of the login form of the webpage.

The source code of the login page includes the mechanism of activating the process for handling the piece of authorization data, for example, the login page further includes the button for user to click, or the background process implemented by Asynchronous JavaScript and XML (AJAX). In the present disclosure, the client 1 packs the piece of authorization data in the authorization field of the HTTP request and sends the request to the server 2. Therefore, after the aforementioned mechanism is activated, the scripting engine needs to generate the contents suitable for being inputted in the authorization field according to the inputted information in the step S111. In practice, when the basic access authentication is dealt, the content is an encoded plain text of the piece of authorization data in Base64. When the digest access authentication is dealt, the content includes a nonce and a hash of the piece of authorization data . . . etc. The authentication method is not limited to HTTP and is available to be dealt in advance or dealt in the source code. The source code is executed in the client 1 and that the server 2 sends the source code in the step S205 means that the authentication method is indicated.

In an embodiment, before, during, or after the step S111, the scripting engine further saves the inputted piece of authorization data in a session storage of the browser or a local database, wherein the session storage is, for example, defined in HTML5, and the local database is, for example, an Indexed Database API, simplified as IndexedDB. The saved piece of authorization data is for the client 1 to request other web pages. For example, the browser is able to access the piece of authorization data saved in the session storage or database by the scripting engine and logins to other web pages which need the same piece of authorization data, or the plug-in of the logined web page is able to access the piece of authorization data saved in the session storage or database by the scripting engine when acquiring the piece of authorization data. When the client 1 is not performing the web authentication of the present disclosure for the first time, the saved piece of authorization data is directly used to be inputted to the login page in the step S109.

The scripting engine executes the source code of the login page and the part of the source code which handles the piece of authorization data includes an application interface which indicates the browser to send the authorization field and the content of the authorization field to the server 2, as shown in the step S113. In an embodiment, the application interface includes the XMLHttpRequest. In other words, the scripting engine takes the contents of the authorization field as the parameters to call the XMLHttpRequest function and sends the HTTP request. The client 1 informs the server 2 the requesting web page or resources again or for the first time in this request, such as filling the path field. In an embodiment the contents of the authorization field is sent with a POST request of HTTP and the authorization field is in the header of the request instead of the body.

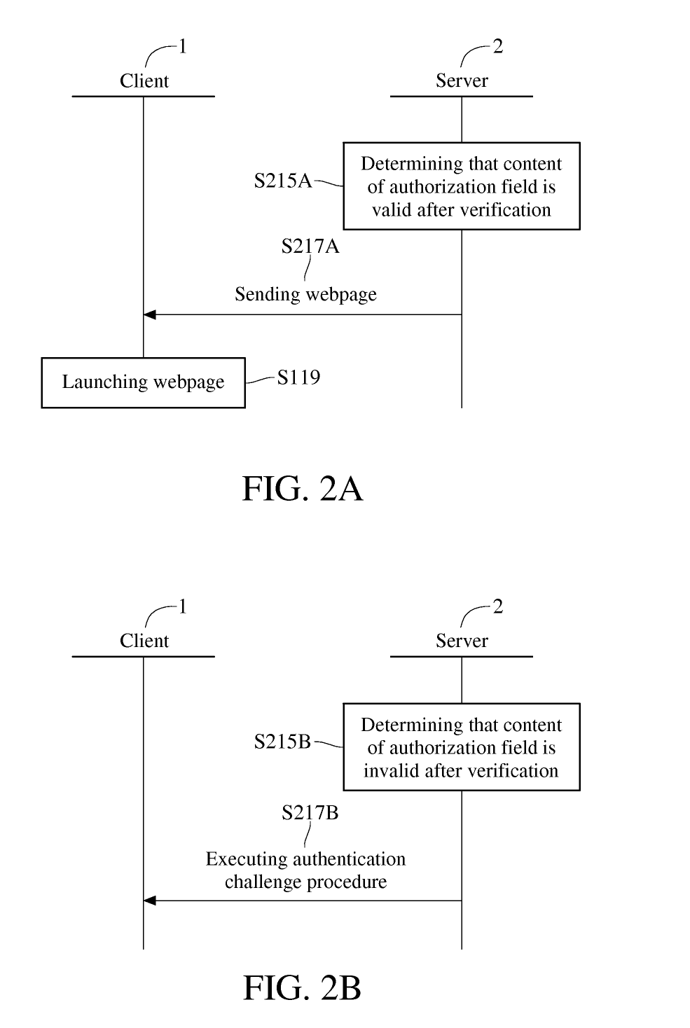

When the client 1 still does not obtain the authorization in the step S113 since offering the attempted GET request in the step S101, for the client 1, the requested webpage can only be launched selectively. In the step S215, the server 2 verifies the content of the received authorization field. For example, the server 2 queries the included or coupled database with the piece of authorization data of limited users according to the user name in the content of the authorization field to obtain the hash value of the corresponding password. The server 2 performs the calculation similar to the step S111 and compares the result with the received content. Please refer to FIG. 2A. When the server 2 determines that the content of the authorization field is correct or the result matches in the step S215A after the verification, the client 1 passes the authentication.

The server 2 obtains the requested webpage from certain storage in the step S101 or S113 and sends the webpage to the client 1 in the step S217A. The client 1 achieves the goal of launching the webpage in the step S119. Please refer to FIG. 2B again. In the step S215B, the server 2 determines whether the content of the authorization field is incorrect or the result does not match after the verification. In the step S217B, the server 2 executes the authentication challenge procedure to the client 1, such as sending the unauthorized message and the web authentication field to the client 1. Generally the unauthorized message and the web authentication field is part of the HTTP server response. The unauthorized message is in the status code field and includes but not limited to “401 Unauthorized”. The purpose of the unauthorized message is to inform the client 1 for not acquiring the authentication.

The web authentication field refers to the WWW-Authenticate field in the header of the response and is for informing the client 1 of the authentication method and the format of the piece of authorization data expected by the server 2 again. In another embodiment, the authentication challenge procedure directs the client 1 to the login page and requests the client 1 to provide the content of the piece of authorization data again. The step possibly indicates that the server 2 goes back to the step S205 or executes similar steps, or indicates the scripting engine of the client 1 through the application interface. Usually, the server 2 sends response according to HTTP and does not know the existence of the application interface. However, when the client 1 executes the step S113 with XMLHttpRequest, the response of the server 2 is packing in the return value of the function of the interface and performing advanced operations by the scripting engine. For example, the engine goes back to the step S107 or executes similar steps according to the source code in the response body sent by the server 2, such as generating at least part of another login page for notifying the user that the previously inputted piece of authorization data is incorrect, the webpage for triggering the user to register for an account, or any resource which the server 2 can provide to the unauthorized client 1.

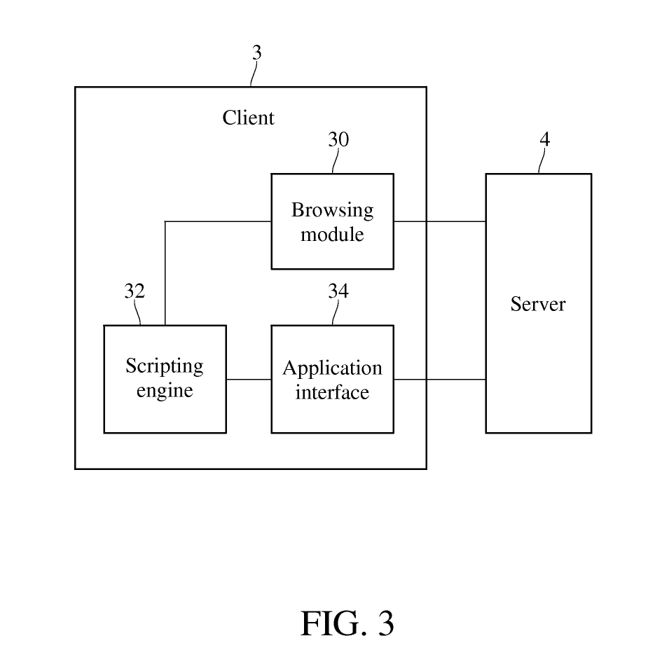

Please refer to FIG. 3 for the coupling relationships between the browser, the scripting engine, and the application interface. FIG. 3 is a block diagram of the web authentication system according to a first embodiment. As shown in FIG. 3, the client 3 includes a browsing module 30, a scripting engine 32, and an application interface 34. The browsing module 30 is coupled to the scripting engine 32. The browsing module 30 is the main user interface of the browser of the client 3 and is capable of sending general HTTP requests and receiving responses, and is also capable of processing the part of non-interpret language of the web page source code, such as Hyper Text Markup Language (HTML) and Cascading Style Sheets (CSS). The scripting engine 32 is further coupled to the application interface 34. The scripting engine 32 and the application interface 34 can be both part of the browser, or all of the browser, or not any of the browser. In order to simplify the explanation, the browsing module 30 and the application interface 34 are coupled to the server 4 respectively in FIG. 3. In practice, the browsing module 30 and the application interface 34 shares the channels between the browser of the client 3 and the server 4, such as the port which the browser launches locally.

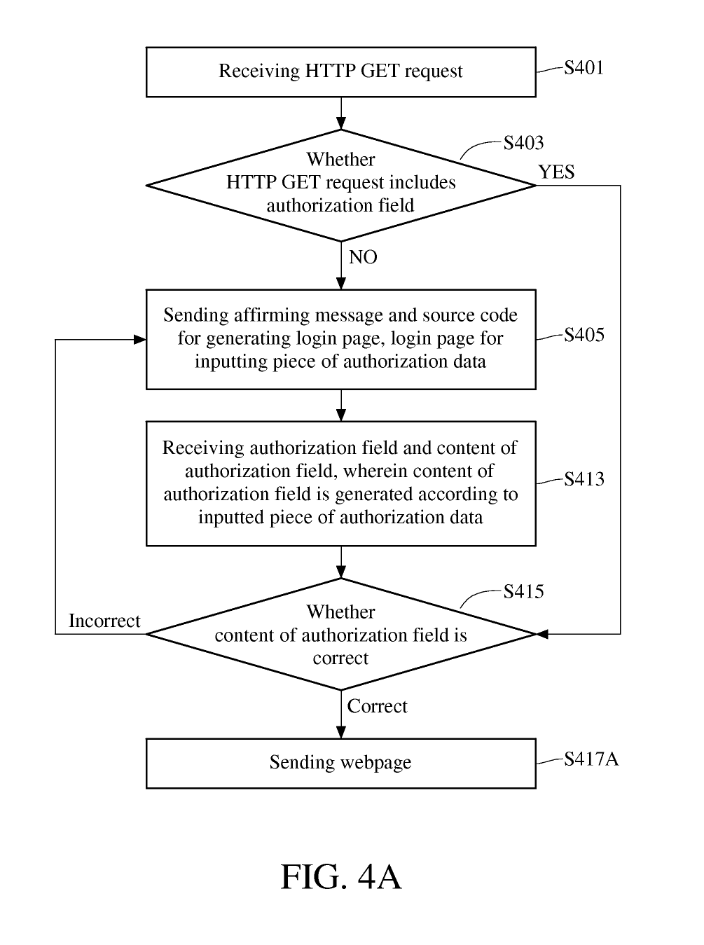

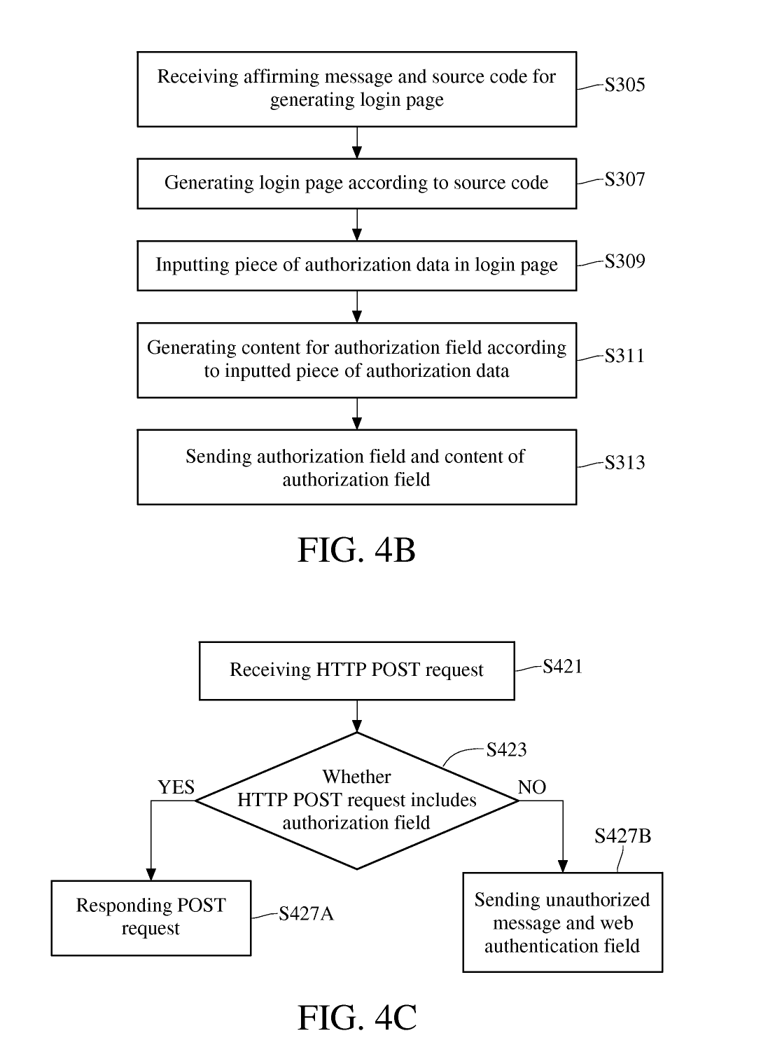

Please refer to FIG. 4A with FIG. 1, FIG. 2A, FIG. 2B, and FIG. 3. FIG. 4A is a flowchart of the sever in the web authentication method according to a first embodiment. Please replace the client 1 with the client 3 and replace the server 2 with the server 4 in the following explanation. The step S401 corresponds to the step S101. In the step S403, the server 4 verifies whether the received GET request includes an authorization field. When the server 4 determines that the GET request does not include an authorization field, the step S403 corresponds to the step S203. In the present embodiment, the GET request in the step S401 indicates the web page or resource which the client 3 wants to access. Therefore, when the server 4 determines that the request includes the authorization field in the step S403, the correctness of the contents is verified in the step S415.

The step S405 corresponds to the step S205 and the login page is provided to the client 3 to input the piece of authorization data in the step S109. The server 4 does not need to know the step S107 to the step S111. The step S413 corresponds to the step S113 and the server 4 recalls the piece of authorization data inputted to the login page using the contents for filling in the authorization field generated in the step S111. The authorization field is sent with a POST request of HTTP and the authorization field is in the header of the request instead of the body. The step S415 corresponds to the step S215. After the verification, when the result is correct, the step S215A is executed, and when the result is incorrect, the step S215B is executed. The step S417A corresponds to the step S217A. In the present embodiment, the authentication challenge procedure selected or configured by the server 4 is executing the step S405 again, wherein the authentication challenge procedure corresponds to the step S217B. As the previous explanation, the server 4 also sends the unauthorized message or instructs the scripting engine 32 to affect the browsing module 30 through the application interface 34.

Please refer to FIG. 4B with FIG. 1 and FIG. 3. FIG. 4B is a flowchart of the web authentication method in FIG. 1 and is illustrated from the perspective of the client 3. Please replace the client 3 with the client 1 and replace the server 4 with the server 2. The step S305 corresponds to the step S205 and the browsing module 30 receives the affirming message and the source code of the login page from the server 4. The browsing module 30 delivers the source code or at least the part written in the interpreted language to the scripting engine 32 to generate at least part of the login page in the step S307 corresponding to the step S107. The browsing module 30 generates the part of the login page which is not related to the interpreted language and combines the part generated by the scripting engine 32 to show the whole page. The step S309 corresponds to the step S109 and the browsing module 30 is responsible for the step. However, when the user clicks the button, such as login, submit, or upload, or the AJAX background process detects the input event as an activation mechanism, the scripting engine 32 takes over and executes the step S311 corresponding to the step S111. In the present embodiment, the application interface 34 is the XMLHttpRequest. In the step S313 corresponding to the S113, the scripting engine 32 delivers the content of the authorization field to the application interface 34. According to the instruction of the scripting engine 32, the application interface 34 packs the authorization field and the content of the authorization field in the aforementioned POST request and the browser sends the POST request to the server 4 through the shared channel of the application interface 34 and the browsing module 30.

Please refer to FIG. 4C with FIG. 3. FIG. 4C is a flowchart of the sever receiving the POST request in the web authentication method according to a first embodiment. When the server 4 receives any POST request which is not necessarily in the context of the web authentication method in the step S421, the method verifies whether the authorization field is included in the request in the step S423. If yes, the step S427A is executed. If no, in the step S427B, the authentication challenge procedure sends the unauthorized message and the web authentication field in the present embodiment. Generally the POST request is used for sending data to the server 4. The server 4 responds the result after handling the data in the step S427A. Because HTTP is stateless, the server 4 is possibly to verify the POST request for sending the authorization field and the content of the authorization field for the existence of the authorization field, that is, the step S421 corresponding to the step S413, and the step S427A includes the step S415.

The web authentication method in the present disclosure combines the advantages of HTTP built-in authentication and the login page with cookie and discards the disadvantages. The basic and digest access authentication are widely supported but the piece of authorization data and the input method is controlled by the browser. The present disclosure replaces the original input interface of the browser with the login page customized with interpreted language. The content of the authorization field is finally sent by the user through the browser and the browser is noticed with the piece of authorization data. Cookie is helpful for the reuse of the piece of authorization data but there are still security concerns and the server has to support dialogs, such as Common Gateway Interface (CGI). The source code of the login page of the present disclosure is used for saving the piece of authorization data to the session storage or local database to solve the aforementioned problem.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A web authentication method for launching a webpage, comprising:
sending a Hypertext Transfer Protocol (HTTP) GET request to a server;
verifying whether the HTTP GET request includes an authorization field;
when the HTTP GET request does not include an authorization field, sending an affirming message and a source code for generating a login page;
generating the login page according to the source code;
inputting a piece of authorization data in the login page;
generating contents for the authorization field according to the inputted piece of authorization data;
sending the authorization field and the content of the authorization field to the sever; and
launching the webpage selectively;
wherein the authorization field and the content of the authorization field are sent to the server by a scripting engine of a browser through an application interface (API), and at least part of the login page is generated by the scripting engine of the browser according to the source code.

2. The method of claim 1, wherein the inputted piece of authorization data is saved in a session storage of the browser.

3. The method of claim 1, wherein the login page comprises a login form and the login form comprises a field of a username and a field of a password, and the piece of authorization data comprises the username and the password.

4. The method of claim 1, wherein the browser sends the authorization field and the content of the authorization field to the sever through a HTTP POST request.

5. The method of claim 4, wherein the step of launching the webpage selectively comprises:
verifying the content of the authorization field;
when the content of the authorization field is invalid, executing an authentication challenge procedure; and
when the content of the authorization field is valid, launching the webpage.

6. The method of claim 1, further comprising:
sending a HTTP POST request to the sever;
verifying whether the HTTP POST request includes the authorization field; and
when the HTTP POST request does not include the authorization field, executing an authentication challenge procedure.

7. The method of claim 5, wherein the authentication challenge procedure comprises sending an unauthorized message and a web authentication field.

8. The method of claim 1, wherein the application interface comprises a XMLHttpRequest application interface.

9. The method of claim 1, wherein the scripting engine comprises a JavaScript engine or a VBScript engine.

10. A web authentication method for launching a webpage, adapted for a server, the web authentication method comprising:
receiving a HTTP GET request;
verifying whether the HTTP GET request includes an authorization field;
when the HTTP GET request does not include the authorization field, sending an affirming message and a source code for generating a login page, the login page for inputting a piece of authorization data; and
receiving the authorization field and the content of the authorization field, wherein the content of the authorization field is generated according to the inputted piece of authorization data;
wherein at least part of the login page is generated by a scripting engine of a browser according to the source code, and the scripting engine of the browser indicates the browser to send the authorization field and the content of the authorization field with a HTTP POST request through a XMLHttpRequest application interface.

11. The method of claim 10, wherein the login page comprises a login form and the login form comprises a field of a username and a field of a password, and the piece of authorization data comprises the username and the password.

12. The method of claim 10, further comprising:
verifying the content of the authorization field;
when the content of the authorization field is invalid, executing an authentication challenge procedure; and
when the content of the authorization field is valid, sending the webpage.

13. The method of claim 10, further comprising:
receiving another HTTP POST request;
verifying whether the another HTTP POST request includes the authorization field; and
when the another HTTP POST request does not include the authorization field, executing an authentication challenge procedure.

14. The method of claim 12, wherein the authentication challenge procedure comprises sending an unauthorized message and a web authentication field.

15. The method of claim 13, wherein the authentication challenge procedure comprises sending an unauthorized message and a web authentication field.

16. A web authentication system for launching a webpage, comprising:
a client including a browsing module and a scripting engine, wherein the browsing module is coupled to the scripting engine;
a server couple to the client via an Internet and receiving a HTTP GET request from the client;
the server verifying whether the HTTP GET request from the client includes an authorization field, wherein when the HTTP GET request does not include the authorization field, the server sends an affirming message and a source code for generating a login page to the client, the login page for inputting a piece of authorization data by the client; and
the client transferring the authorization field and the content of the authorization field to the server, wherein the content of the authorization field is generated according to the inputted piece of authorization data;
wherein at least part of the login page is generated by the scripting engine of the browsing module according to the source code, and the scripting engine of the browsing module indicates the browsing module to send the authorization field and the content of the authorization field with a HTTP POST request through a XMLHttpRequest application interface.

17. The system of claim 16, wherein the login page comprises a login form and the login form comprises a field of a username and a field of a password, and the piece of authorization data comprises the username and the password.

18. The system of claim 16, further comprising:
the server verifying the content of the authorization field;
when the content of the authorization field is invalid, the server executing an authentication challenge procedure; and
when the content of the authorization field is valid, the server sending the webpage.

19. The system of claim 16, further comprising:
the server receiving another HTTP POST request;
the server verifying whether the another HTTP POST request includes the authorization field; and
when the another HTTP POST request does not include the authorization field, the server executing an authentication challenge procedure.

20. The system of claim 18, wherein the authentication challenge procedure comprises sending an unauthorized message and a web authentication field.
